(19) United States
(12) Patent Application Publication
(10) Pub. No.: US 2007/0058706 A1
(43) Pub. Date: Mar. 15, 2007

(54) Apparatus and method for detecting asynchronous transmission in a wireless communication system

(75) Inventor: Cheol-Soo Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung electronics Co., Ltd.

(21) Appl. No.: 11/500,423

(22) Filed: Aug. 8, 2006

(30) Foreign Application Priority Data
Aug. 8, 2005 (KR) 10-2005-0072093

(51) Int. Cl. H04L 5/16

(52) U.S. Cl. 375/222

(57) ABSTRACT

An apparatus and a method are provided for detecting asynchronous transmission in a wireless communication system. In a transmitter, a correlator correlates a baseband transmission sample signal with a preamble signal. A decider detects a peak among correlations received from the correlator and determines whether transmission of the transmission sample signal is asynchronous by comparing a frame reference time with a detection time of the peak.

### CROSS-REFERENCE TO RELATED APPLICATION

This application claims the benefit under 35 U.S.C. §119(a) of Korean Patent Application No. 10-2005-0072093, entitled “Apparatus and Method for Detecting Asynchronous Transmission in a Wireless Communication System”, filed in the Korean Intellectual Property Office on Aug. 8, 2005, the entire disclosure of which is incorporated herein by reference.

### BACKGROUND OF THE INVENTION

1. Field of the Invention

The present invention relates generally to an apparatus and method for detecting asynchronization in a wireless communication system. In particular, the present invention relates to an apparatus and method for detecting asynchronous transmission using a preamble in a Time Division Duplexing (TDD) wireless communication system.

2. Description of the Related Art

In a TDD wireless communication system, asynchronization-incurred interference affects other systems as well as the TDD system. Therefore, time synchronization is very critical to system operation.

FIG. 1 illustrates interference caused by an asynchronous transmission signal in a typical TDD wireless communication system.

Referring to FIG. 1, a downlink and an uplink are divided in time in the TDD system. Base Stations (BSs) send signals or data to Mobile Stations (MSs) during the downlink period and receive signals from the MSs during the uplink period. Guard regions called a Transmit/Receive Transition Gap (TTG) and a Receive/transmit Transition Gap (RTG) are defined between the downlink period and the uplink period.

A normal BS sends and receives signals at a correct timing in synchronization to a Global Positioning System (GPS) 1 Pulse Per Second (1PPS) signal, as illustrated by BS A. However, an asynchronous BS sends and receives signals at a wrong timing (e.g., drift A), as illustrated by BS B.

If BS A and BS B are neighboring each other, reception (Rx) data of BS A overlaps with transmission (Tx) data of BS B, and Tx data of BS A overlaps with Rx data of BS B. Consequently, the BSs and MSs cannot receive signals normally.

As described above, time asynchronization between BSs causes inter-cell interference and performance degradation, and in the worst case, suspends service in the TDD communication system.

Accordingly, a need exists for a system and method for preventing inter-cell interference and performance degradation due to time asynchronization between BSs.

### SUMMARY OF THE INVENTION

An object of embodiments of the present invention is to substantially solve at least the above problems and/or disadvantages, and to provide at least the advantages described below. Accordingly, an object of embodiments of the present invention is to provide an apparatus and method for ensuring time synchronization between BSs in a wireless communication system.

Another object of embodiments of the present invention is to provide an apparatus and method for diagnosing frame synchronization in a wireless communication system.

Another object of embodiments of the present invention is to provide an apparatus and method for detecting asynchronous transmission in a wireless communication system.

Another object of embodiments of the present invention is to provide an apparatus and method for detecting asynchronous transmission using a preamble in a wireless communication system.

Another object of embodiments of the present invention is to provide an apparatus and method for automatically blocking asynchronous transmission, if detected, in a wireless communication system.

The above and other objects of embodiments of the present invention are achieved by providing an apparatus and method for detecting asynchronous transmission in a wireless communication system.

According to one aspect of embodiments of the present invention, a transmitter of a wireless communication system is provided, comprising a correlator to correlate a baseband transmission sample signal with a preamble signal, and a decider to detect a peak among correlations received from the correlator and determine whether transmission of the transmission sample signal is asynchronous by comparing a frame reference time with a detection time of the peak.

According to another aspect of embodiments of the present invention, a transmitter of a wireless communication system is provided, comprising a MODEM to generate a transmission sample signal, and an asynchronization detector to detect a peak by correlating the transmission sample signal with a preamble signal and determine whether transmission of the transmission sample signal is asynchronous by comparing a frame reference time with a detection time of the peak.

According to a another aspect of embodiments of the present invention, a method of detecting asynchronous transmission in a transmitter of a wireless communication system is provided, wherein a peak is detected by correlating a baseband transmission sample signal with a preamble signal, and an error between a detection time of the peak and a frame reference time is calculated and if the error is larger than a predetermined value, it is determined that transmission of the transmission sample signal is asynchronous.

According to another aspect of embodiments of the present invention, a method of detecting asynchronous transmission in a transmitter of a wireless communication system is provided, wherein a snapshot of transmission sample data received from a MODEM is taken at every predetermined time interval, a peak is detected by correlating the snapshot of the transmission sample data with predetermined preamble sample data, and an error between a detection time of the peak and a frame reference time is calculated and if the error is larger than a predetermined value, it is determined that transmission of the transmission sample data is asynchronous.

### BRIEF DESCRIPTION OF THE DRAWINGS

The above and other objects, features and advantages of embodiments of the present invention will become more apparent from the following detailed description when taken in conjunction with the accompanying drawings, in which:

FIG. 1 illustrates interference caused by an asynchronous transmission signal in a typical TDD wireless communication system;

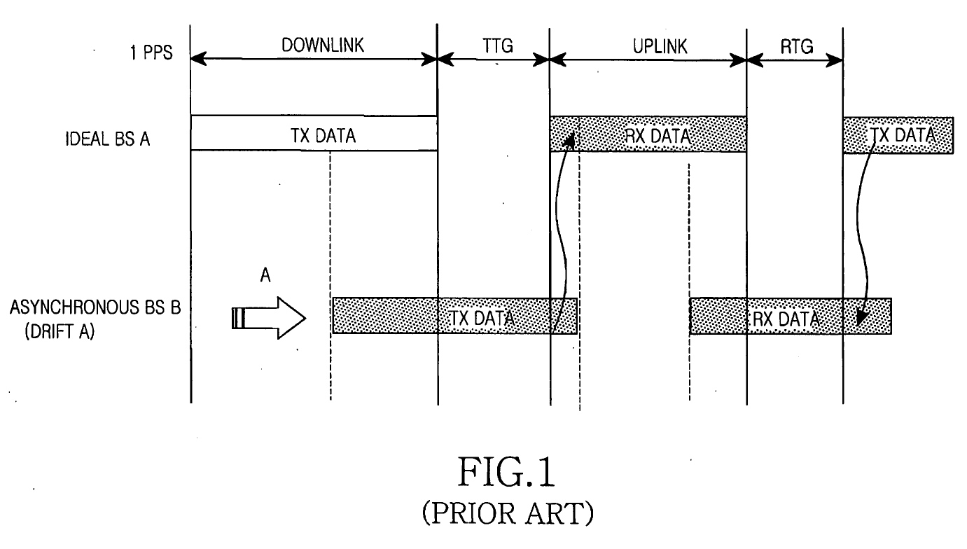

FIG. 2 is a block diagram of a BS in a TDD wireless communication system according to an exemplary embodiment of the present invention;

FIG. 3 is a detailed block diagram of an asynchronization detector according to an exemplary embodiment of the present invention;

FIG. 4 illustrates the relation between a Tx delay and the correlation between a Tx sample signal and a preamble signal according to an exemplary embodiment of the present invention; and

FIG. 5 is a flowchart illustrating a synchronization diagnosis operation in the asynchronization detector according to an exemplary embodiment of the present invention.

### DETAILED DESCRIPTION OF THE EXEMPLARY EMBODIMENTS

Exemplary embodiments of the present invention will be described herein below with reference to the accompanying drawings. In the following description, well-known functions or constructions are not described in detail since they would obscure the invention in unnecessary detail.

Embodiments of the present invention are intended to provide a technique for detecting asynchronous transmission using a baseband preamble signal in a wireless communication system. While the following description will be made in the context of a TDD wireless communication system using GPS time, it is to be understood that embodiments of the present invention are applicable to any frame-based communication system. Also, while exemplary embodiments of the present invention will be described in the context of a BS, the same description applies to an MS that sends data in frames.

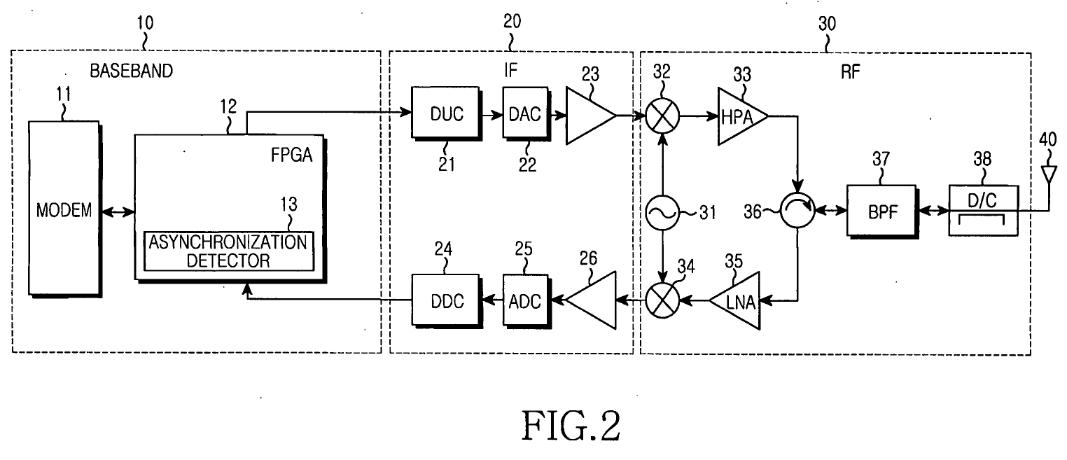

FIG. 2 is a block diagram of a BS in a TDD wireless communication system according to an exemplary embodiment of the present invention.

Referring to FIG. 2, the BS comprises a baseband processor 10, an Intermediate Frequency (IF) processor 20, and a Radio Frequency (RF) processor 30. The baseband processor 10 comprises a baseband Modulator-Demodulator (MODEM) 11 and a Filed Programmable Gate Array (FPGA) 12. The IF processor 20 comprises a Digital UpConverter (DUC) 21, a Digital-to-Analog Converter (DAC) 22, a first IF amplifier 23, a Digital DownConverter (DDC) 24, an Analog-to-Digital Converter (ADC) 25, and a second IF amplifier 26. The RF processor 30 comprises a Local Oscillator (LO) 31, a first mixer 32, a High Power Amplifier (HPA) 33, a second mixer 34, a Low Noise Amplifier (LNA) 35, a circulator 36, a Band Pass Filter (BPF) 37, and a Directional Coupler (D/C) 38.

For transmission, the MODEM 11 comprises a Central Processing Unit (CPU), a source encoder and decoder (e.g. Voice Coder (VOCODER)), a channel encoder and decoder, and a digital modulator and demodulator. In an Orthogonal Frequency Division Multiplexing (OFDM) system, for example, the MODEM 11 channel-encodes source-coded data and OFDM-modulates the channel-coded data (e.g. Inverse Fast Fourier Transform (IFFT)), thus outputting a baseband digital signal.

The FPGA 12 provides the Tx data received from the MODEM 11 to the DUC 21 and Rx data received from the DDC 24 to the MODEM 11. In accordance with an exemplary embodiment of the present invention, the FPGA 12 comprises an asynchronization detector 13. The asynchronization detector 13 detects a transmission time using a baseband preamble signal, compares the detected transmission time with an absolute time (GPS time), and blocks the Tx data from being provided to the DUC 21, if they are different.

The DUC 21 upconverts the baseband signal received from the FPGA 12 into an IF signal. The DAC 22 converts the digital signal received from the DUC 21 into an analog signal and the first IF amplifier 23 amplifies the analog signal.

The LO 31 generates a local oscillation frequency by which to upconvert the IF signal into an RF signal. The first mixer 32 mixes the amplified signal with the local oscillation frequency (or carrier), thereby generating the RF signal. The HPA 33 amplifies the power of the RF signal.

The circulator 36 provides the power-amplified signal to the BPF 37 and a signal from the BPF 37 to the LNA 35 in the illustrated direction. The BPF 37 band-pass-filters the Tx and Rx signals. The D/C 38 is connected between the BPF 37 and an antenna 40, for coupling the Tx and Rx signals. The coupled signal is used to monitor abnormality of the Tx and Rx signals.

For reception, a signal received through the antenna 40 is provided to the LNA 35 via the D/C 38, the BPF 37, and the circulator 36. The LNA 35 amplifies the received signal, suppressing noise. The second mixer 34 mixes the local oscillation frequency received from the LO 31 with the signal received from the LNA 35, thus generating an IF signal.

The second IF amplifier 26 amplifies the IF signal and the ADC 25 converts the analog signal received from the second IF amplifier 26 into a digital signal. The DDC 24 downconverts the IF digital signal into a baseband signal.

The FPGA 12 provides the data received from the DDC 24 to the MODEM 11. In an OFDM system, for example, the MODEM 11 OFDM-demodulates input sample data by Fast Fourier Transform (FFT) and channel-decodes the OFDM-demodulated data, thereby recovering received data.

As described above, a reason for detecting and diagnosing asynchronization in the baseband processor 10 is that asynchronization detection and diagnosis in the IF processor 20 or the RF processor 30 would require re-demodulation of an IF or RF signal for baseband preamble correlation, thus increasing circuit implementation complexity.

Now a detailed description will be made below of the asynchronization detector 13 for diagnosing time synchronization using a baseband preamble signal.

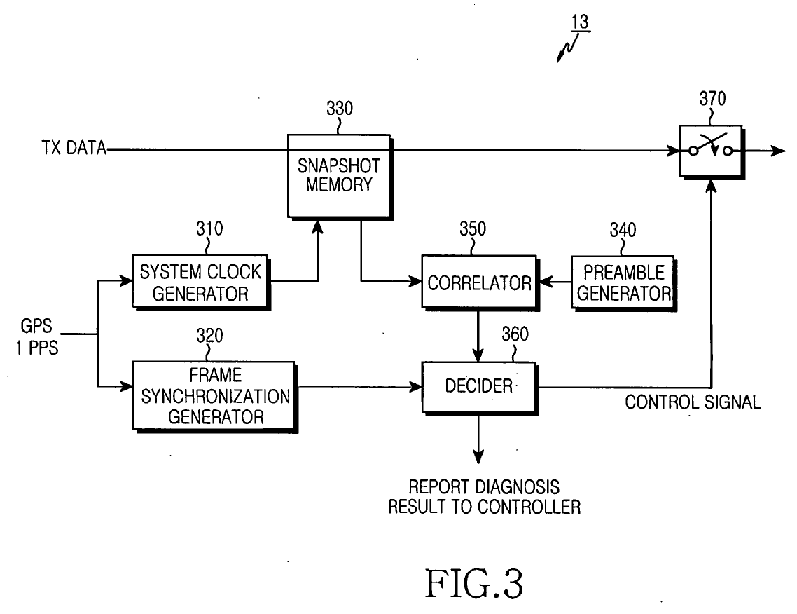

FIG. 3 is a detailed block diagram of the asynchronization detector 13 according to an exemplary embodiment of the present invention.

Referring to FIG. 3, the asynchronization detector 13 comprises a system clock generator 310, a frame synchronization generator 320, a snapshot memory 330, a preamble generator 340, a correlator 350, a decider 360, and a switch 370.

The system clock generator 310 generates a system clock signal in accordance with a GPS 1PPS signal. The frame synchronization generator 320 generates a frame synchronization signal based on the GPS 1PPS. For example, if a frame period is 5 ms, the frame synchronization signal is provided to the decider 360 every 5 ms.

The snapshot memory 330 takes a snapshot of Tx sample data every symbol period (e.g. 20 ns) according to the system clock signal. The preamble generator 340 generates a predetermined preamble signal. In an IEEE 802.16 system, the preamble signal is created in a predetermined pattern according to a cell Identification (ID). The preamble generator 340 can previously store the cell ID, receive it from the MODEM 11 during system initialization, or acquire it externally during operation. Then the preamble generator 340 generates the preamble signal based on the cell ID. Alternatively, the preamble generator 340 can preserve sample data corresponding to preamble symbols and then provide them to the correlator 350.

The correlator 350 correlates the preamble signal with the sample data successively received from the snapshot memory 330. The decider 360 compares the correlation with a predetermined threshold, to thereby detect a peak. Upon detection of the peak, the decider 360 compares the time of the peak detection with the frame synchronization time acquired from the frame synchronization generator 320. If the error between them is larger than a predetermined threshold, the decider 360 controls the switch 370 via a control signal to switch off (or block) the Tx data.

The decider 360 also detects a frame period (or transmission interval) based on the interval between success peaks and compares the detected frame period with a predetermined frame period. If the error between the detected frame period and the predetermined frame period is larger than a predetermined threshold, the decider 360 switches off the switch 370. The decider 360 can further report the diagnosis result to the high-layer controller, i.e. the CPU.

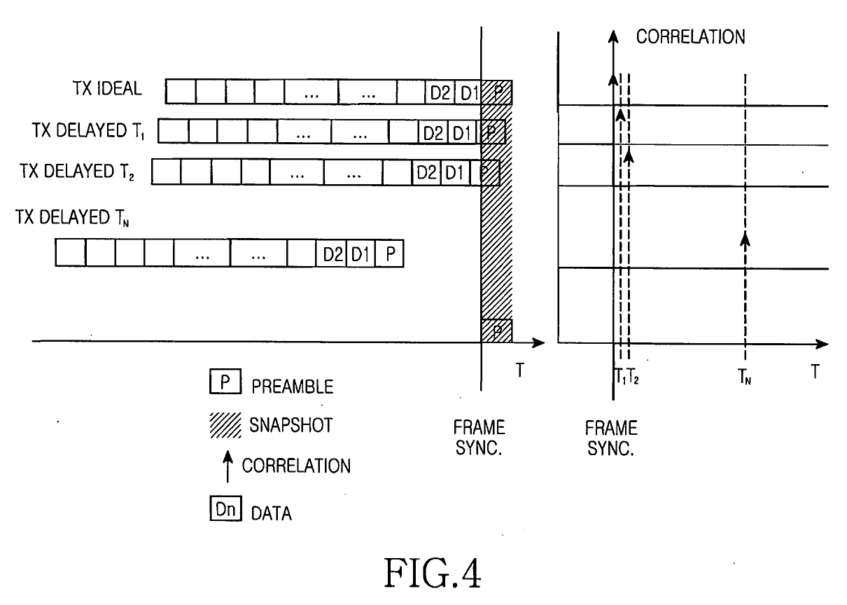

FIG. 4 illustrates the relation between a Tx delay and the correlation between a Tx sample signal and a preamble signal according to an exemplary embodiment of the present invention.

Referring to FIG. 4, Tx ideal denotes a normal Tx signal, Tx Delayed T₁ denotes is a Tx signal delayed by T₁ from frame synchronization (frame sync), Tx Delayed T₂ denotes is a Tx signal delayed by T₂ from frame sync, and Tx Delayed T_{N} denotes is a Tx signal delayed by T_{N} from frame sync.

When the maximum correlations (i.e. peaks) between the four respective Tx signals and a predetermined preamble signal are presented along the time axis as illustrated in FIG. 4, the peak of the first Tx signal is detected at the frame sync accurately, and the peaks of the second, third and fourth Tx signals are detected apart from the frame sync by T₁, T₂, and T_{N}, respectively.

The asynchronization detector 13 detects an error between the frame sync and the peak detected time, and if the error exceeds the predetermined threshold, blocks transmission.

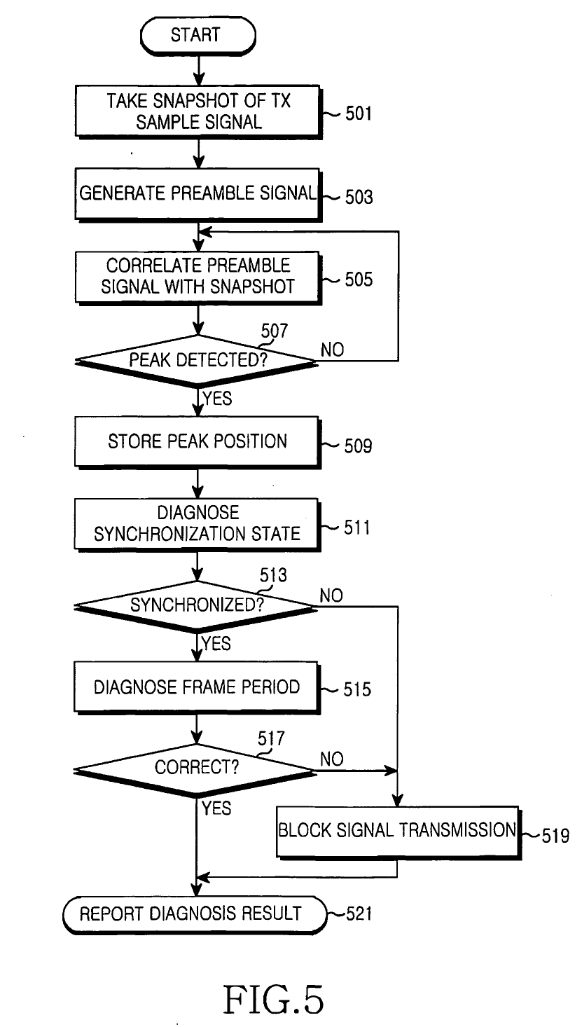

FIG. 5 is a flowchart illustrating a synchronization diagnosis operation in the asynchronization detector 13 according to an exemplary embodiment of the present invention.

Referring to FIGS. 2-5, the asynchronization detector 13 takes a snapshot of a Tx sample signal on a symbol-by-symbol basis in step 501, generates a predetermined preamble signal in step 503, and correlates the Tx sample signal with the preamble signal in step 505. The asynchronization detector 13 detects a peak by comparing the correlation with a predetermined value in step 507. If the peak is not detected, the asynchronization detector 13 returns to step 505, for the next correlation.

Upon detection of the peak, the asynchronization detector 13 stores the position (time) of the sample data having the peak in a memory in step 509. In step 511, the asynchronization detector 13 compares the peak detected time with a frame reference time (i.e. frame sync) based on the GPS time, thereby diagnosing the synchronization state of the Tx signal. The asynchronization detector 13 determines whether the Tx signal is synchronized in step 513. The determination is made by checking whether the error between the frame reference time and the peak detected time is less than a predetermined value. If the Tx signal is asynchronous, the asynchronization detector 13 blocks the transmission in step 519 and proceeds to step 521.

If the Tx signal is synchronized, the asynchronization detector 13 detects a transmission period using peak positions stored in the memory and compares the detected transmission period with a predetermined frame period, thereby diagnosing the frame period in step 515. The detected transmission period may be the latest transmission period or the average of a plurality of transmission periods.

In step 517, the asynchronization detector 13 determines whether the frame period is correct by checking whether the error between the detected frame period and a predetermined frame period is less than a predetermined threshold. If the frame period is incorrect, the asynchronization detector 13 blocks the transmission in step 519 and goes to step 521. If the frame period is correct, the asynchronization detector 13 goes to step 521, where it reports the diagnosis result to the high-layer controller.

Exemplary embodiments of the present invention can also be written as computer programs and can be implemented in systems that execute the programs using a computer-readable recording medium. Examples of the computer-readable recording medium comprise magnetic storage media (e.g., ROM, floppy disks, hard disks, etc.), optical recording media (e.g., CD-ROMs, or DVDs), and storage media such as carrier waves (e.g., transmission through the Internet).

In accordance with embodiments of the present invention as described above, the asynchronous operation of a BS is detected beforehand, and thus, the asynchronous transmission from the BS is blocked automatically. Therefore, the safety of overall system operation is ensured. Since a baseband signal is used for asynchronization detection, circuit complexity and accuracy can be improved. Furthermore, a TDD period can be diagnosed through measuring of a frame period.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A transmitter in a wireless communication system, comprising:
a correlator for correlating a baseband transmission sample signal with a preamble signal; and
a decider for detecting a peak among correlations received from the correlator and determining whether transmission of the transmission sample signal is asynchronous by comparing a frame reference time with a detection time of the peak.

2. The transmitter of claim 1, wherein the frame reference time is based on Global Positioning System (GPS) time.

3. The transmitter of claim 1, wherein the decider is configured to determine that the transmission is asynchronous if the error between the frame reference time and the peak detection time is larger than a predetermined value.

4. The transmitter of claim 1, wherein the decider is configured to detect a transmission period based on the interval between successive peaks and determine whether the transmission is asynchronous by comparing the transmission period with a predetermined frame period.

5. The transmitter of claim 1, further comprising a switch for blocking the transmission of the transmission sample signal, wherein if the transmission is asynchronous, the decider is configured to control the switch to block the transmission of the transmission sample signal.

6. The transmitter of claim 1, further comprising a snapshot memory for taking a snapshot of the transmission sample signal output from a modulator-demodulator (MODEM) at predetermined time intervals and providing the snapshot to the correlator.

7. The transmitter of claim 1, further comprising a frame synchronization generator for providing the frame reference time based on the GPS time to the decider.

8. The transmitter of claim 1, further comprising a preamble generator for generating the preamble signal and providing the preamble signal to the decider.

9. A transmitter in a wireless communication system, comprising:
a modulator-demodulator (MODEM) for generating a transmission sample signal; and
a detector for detecting a peak by correlating the transmission sample signal with a preamble signal and determining whether transmission of the transmission sample signal is asynchronous by comparing a frame reference time with a detection time of the peak.

10. The transmitter of claim 9, wherein the asynchronization detector comprises:
a switch for blocking the transmission of the transmission sample signal;
a correlator for correlating the transmission sample signal with the preamble signal; and
a decider for detecting the peak among correlations received from the correlator, determining whether the transmission is asynchronous by comparing a frame reference time with the peak detection time, and blocking the transmission by controlling the switch, if the transmission is asynchronous.

11. The transmitter of claim 10, wherein the decider is configured to determine that the transmission is asynchronous if the error between the frame reference time and the peak detection time is larger than a predetermined value.

12. The transmitter of claim 10, wherein the decider is configured to detect a transmission period based on the interval between successive peaks and determine whether the transmission is asynchronous by comparing the transmission period with a predetermined frame period.

13. The transmitter of claim 10, further comprising a snapshot memory for taking a snapshot of the transmission sample signal received from the MODEM at predetermined time intervals and providing the snapshot to the correlator.

14. The transmitter of claim 9, wherein the frame reference time is based on Global Positioning System (GPS) time.

15. The transmitter of claim 9, further comprising;
an intermediate frequency (IF) processor for converting the transmission sample signal received from the asynchronization detector into an IF signal and converting the IF signal into an analog signal; and
a radio frequency (RF) processor for converting the signal received from the IF processor into an RF signal and amplifying the power of the RF signal, for transmission.

16. A method of detecting asynchronous transmission in a transmitter in a wireless communication system, comprising the steps of:
detecting a peak by correlating a baseband transmission sample signal with a preamble signal;
calculating an error between a detection time of the peak and a frame reference time; and
determining that transmission of the transmission sample signal is asynchronous, if the error is larger than a predetermined value.

17. The method of claim 16, further comprising the steps of:
detecting a transmission period based on an interval between detected successive peaks;
calculating an error between the detected transmission period and a predetermined frame period; and
determining that the transmission is asynchronous, if the error is larger than a predetermined value.

18. The method of claim 16, wherein the frame reference time is based on Global Positioning System (GPS) time.

19. The method of claim 16, further comprising the step of blocking the transmission of the transmission sample signal, if the transmission is asynchronous.

20. A method of detecting asynchronous transmission in a transmitter in a wireless communication system, comprising the steps of:
taking a snapshot of transmission sample data received from a modulator-demodulator (MODEM) at predetermined time intervals;
detecting a peak by correlating the snapshot of the transmission sample data with predetermined preamble sample data;
calculating an error between a detection time of the peak and a frame reference time; and
determining that transmission of the transmission sample data is asynchronous, if the error is larger than a predetermined value.

21. The method of claim 20, further comprising the step of blocking the transmission of the transmission sample signal, if the transmission is asynchronous.

22. The method of claim 20, further comprising the steps of:
detecting a transmission period based on an interval between detected successive peaks;
calculating an error between the detected transmission period and a predetermined frame period; and
determining that the transmission is asynchronous, if the error is larger than a predetermined value.

23. The method of claim 20, wherein the frame reference time is based on Global Positioning System (GPS) time.

24. A computer-readable recording medium having recorded thereon a computer-readable program for controlling a transmitter in a wireless communication system, comprising:
a first set of instructions for controlling a correlator to correlate a baseband transmission sample signal with a preamble signal; and
a second set of instructions for controlling a decider to detect a peak among correlations received from the correlator and determine whether transmission of the transmission sample signal is asynchronous by comparing a frame reference time with a detection time of the peak.

25. The computer-readable recording medium of claim 24, wherein the second set of instructions comprise a set of instructions to determine that the transmission is asynchronous if the error between the frame reference time and the peak detection time is larger than a predetermined value.

26. The computer-readable recording medium of claim 24, wherein the second set of instructions comprise a set of instructions to detect a transmission period based on the interval between successive peaks and determine whether the transmission is asynchronous by comparing the transmission period with a predetermined frame period.

27. The computer-readable recording medium of claim 24, further comprising a set of instructions for controlling a switch to block the transmission of the transmission sample signal, if the transmission is asynchronous.

28. The computer-readable recording medium of claim 24, further comprising a set of instructions for controlling a snapshot memory to take a snapshot of the transmission sample signal output from a modulator-demodulator (MODEM) at predetermined time intervals and provide the snapshot to the correlator.

29. The computer-readable recording medium of claim 24, further comprising a set of instructions for controlling a frame synchronization generator to provide the frame reference time based on the GPS time to the decider.

30. The computer-readable recording medium of claim 24, further comprising a set of instructions for controlling a preamble generator to generate a preamble signal and provide the preamble signal to the decider.
